(19) United States
(12) Patent Application Publication
(10) Pub. No.: US 2002/0116152 A1
(43) Pub. Date: Aug. 22, 2002

(54) Method of executing benchmark test

(76) Inventor: Genichi Tanaka, Tokyo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/922,768

(22) Filed: Aug. 7, 2001

(30) Foreign Application Priority Data
Feb. 19, 2001 (JP) 2001-42202

(51) Int. Cl. G06F 11/30; G06F 15/00; G21C 17/00

(52) U.S. Cl. 702/186

(57) ABSTRACT

A method of executing a benchmark test according to the present invention comprises: a benchmark test proceeding step in which at least one standard input data preinstalled in a computer is fed to a plurality of tools which are also preinstalled in a computer so as to execute a benchmark test for these tools, a benchmark test result storing step in which a plurality of benchmark test results obtained during the benchmark test proceeding step are stored, and a benchmark test result outputting step in which at least one test result is outputted on a test operator's request from the plurality of benchmark test results stored during the test result storing step. Due to this construction, benchmark test operators do not have to prepare individually an input data and a plurality of test tools for themselves, making it possible thereby to reduce the total cost for performing the benchmark test as a whole.

### BACKGROUND OF THE INVENTION

1. Field of the Invention

The present invention relates to a method of executing a benchmark test with respect to a plurality of tools.

2. Description of the Related Art

FIG. 9 is a flowchart showing the conventional method of executing a benchmark test. Here, the benchmark test is a test for evaluating the performance of tools stored in a computer, in accordance with the time required for execution of the test, memory capacity used during the test operation, the processed result and so on after feeding input data thereto.

In the figure, reference numeral 1 denotes an input data peculiar to the one who executes a benchmark test (hereinafter referred to as a “benchmark test operator” or just as a “test operator”), and 2a to 2c denote tools to be tested by a benchmark test. In this test, the same input data 1 is fed to each of the tools 2a to 2c, and the results of the processing executed by use of these tools are the benchmark test results 3a to 3c.

The operation of the above benchmark test will now be explained, taking up a semiconductor automatic placing and routing tool as an example.

In FIG. 9, the input data 1 can be a netlist showing the logical connections, layout information, cell-timing information, floor plan information, design-timing constraint information and so on, and this input data is fed to each of the tools 2a to 2c so as to obtain the benchmark test results 3a to 3c. These benchmark test results 3a to 3c each can be a list of the resulted layout, the resulted timing and so on as the final result of the placing and routing operation, and can also be a function check list for showing whether a timing drive function, a clock tree constructing function and so on are provided.

Since the conventional method of executing a benchmark test is configured as explained above, the benchmark test operators have to prepare individually the input data 1 and the tools to be tested 2a to 2c as benchmark test targets for executing the benchmark test and outputting the test results 3a to 3c thereof. Also since the benchmark test operator performs the benchmark test individually, the result of each of the benchmark tests was for his own, and has never been made open to other benchmark test operators.

Due to this fact, each of the benchmark test operators has to prepare input data and a plurality of test tools for himself, raising thereby the total cost for performing the benchmark test as a whole.

### SUMMARY OF THE INVENTION

The present invention has been proposed to solve the problems aforementioned, and it is an object of the present invention to provide a method of executing a benchmark test in which each of the benchmark test operators does not have to prepare input data and a plurality of test tools for himself, lowering thereby the total cost for executing the benchmark test.

A method of executing a benchmark test for accomplishing the above object of the present invention according to a first aspect thereof is constructed in such a manner that it comprises: a benchmark test proceeding step in which at least one standard input data preinstalled in a computer is fed to a plurality of tools also preinstalled in a computer so as to execute a benchmark test with respect to these tools, a benchmark test result storing step in which a plurality of benchmark test results obtained by the benchmark test proceeding step are stored, and a benchmark test result outputting step in which at least one of the plurality of benchmark test results stored during the test result storing step is outputted on the operator's request.

A method of executing a benchmark test according to another aspect of the present invention is constructed in such a manner that there are a plurality of standard input data provided in the benchmark test proceeding step, and only selected ones of the standard input data out of the plurality of standard input data are fed to each of the plurality of tools on request in order to execute the benchmark test with respect to these tools.

A method of executing a benchmark test according to further aspect of the present invention is constructed in such a manner that a test operator's own input data is further provided through transmission on request, and at least one of the test operator's own input data and the standard input data is fed to the plurality of tools in order to execute the benchmark test with respect to these tools.

A method of executing a benchmark test according to further aspect of the present invention is constructed in such a manner that the standard input data is input, on request, to one or more than one tools selected out of the plurality of tools in order to execute the benchmark test for those selected tools.

A method of executing a benchmark test according to further aspect of the present invention is constructed in such a manner that only the required benchmark test results out of the plurality of benchmark test results stored during the benchmark test result storing step are outputted in a required format.

A method of executing a benchmark test according to further aspect of the present invention is constructed in such a manner that only the required benchmark test results out of the plurality of benchmark test results stored during the benchmark test result storing step are outputted on payment.

### BRIEF DESCRIPTION OF THE DRAWINGS

FIG. 1 is a flowchart showing the method of executing a benchmark test according to a first embodiment of the present invention.

FIG. 2 is a flowchart showing the method of executing a benchmark test according to a second embodiment of the present invention.

FIG. 3 is a flowchart showing the method of executing a benchmark test according to a third embodiment of the present invention.

FIG. 4 is a flowchart showing the method of executing a benchmark test according to a fourth embodiment of the present invention.

FIG. 5 is a flowchart showing the method of executing a benchmark test according to a fifth embodiment of the present invention.

FIG. 6 is an overall structural view showing the case in which the method of executing a benchmark test according to a sixth embodiment of the present invention is applied to the Internet.

FIG. 7 is a functional block diagram showing the benchmarking system according to the sixth embodiment of the present invention.

FIG. 8 is a flowchart showing the method of executing a benchmark test according to the sixth embodiment of the present invention.

FIG. 9 is a flowchart showing the conventional method of executing a benchmark test.

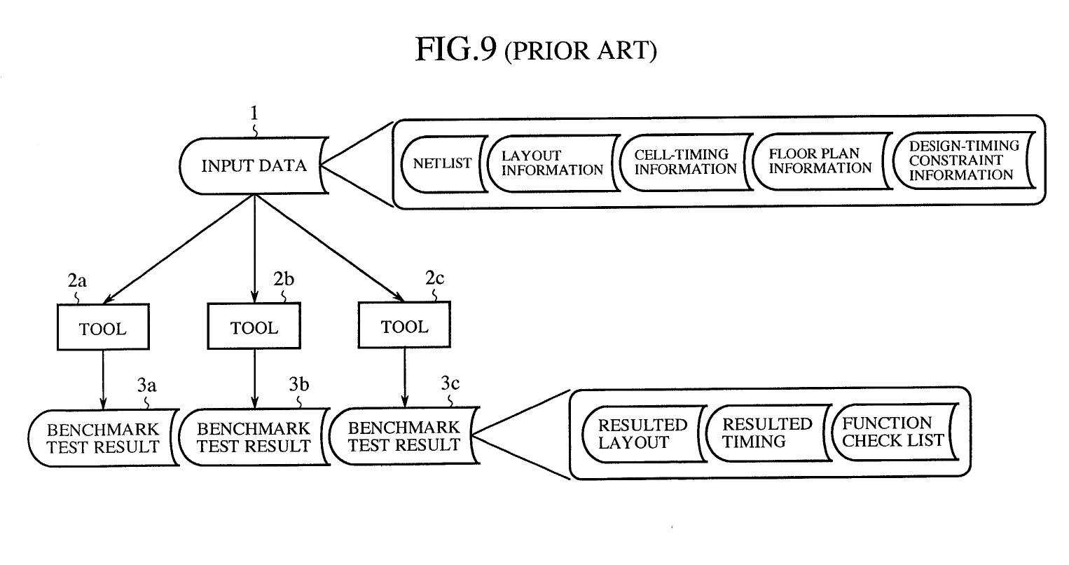

### DETAILED DESCRIPTION OF THE PREFERRED EMBODIMENTS

Several embodiments of the present invention are now explained below.

(First Embodiment)

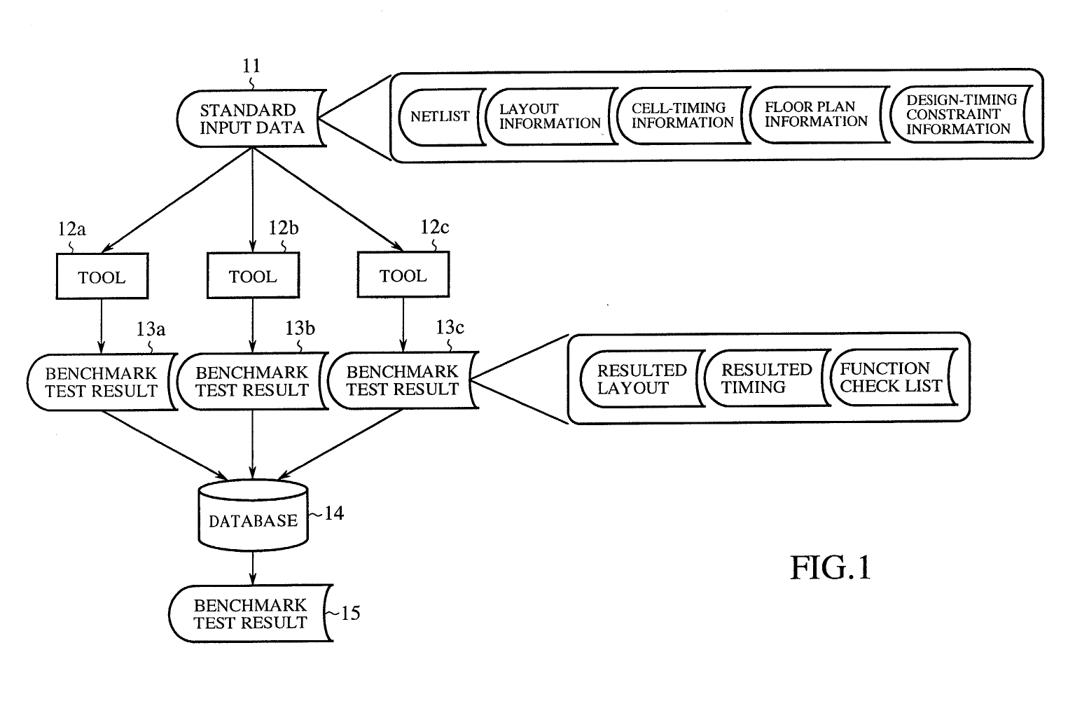

FIG. 1 is a flowchart showing the method of executing a benchmark test according to a first embodiment of the present invention. Here, the benchmark test is a test for evaluating the performance of tools stored in a computer, in accordance with the time required for executing the test, memory capacity used during the test operation, the processed result and so on after feeding input data thereto.

In the figure, reference numeral 11 denotes a standard input data preinstalled in a computer, and numerals 12a to 12c are tools also preinstalled in a computer each as a target of benchmark test. Here, it is shown a state in which a benchmark test for three tools 12a to 12c is made possible, although any number of tools other than three can be tested.

In response to a request from a benchmark test operator, the same standard input data 11 is fed to each of the plurality of tools 12a to 12c to execute a benchmark test for these three tools 12a to 12c (a benchmark test proceeding step). In this case, the results of the benchmark test executed in each of the tools 13a to 13c are the benchmark test results 13a to 13c.

Then, the thus output benchmark test results 13a to 13c are stored in a database 14 (a benchmark test result storing step).

Further, the price is determined in response to an output request from the benchmark test operator, and only a required benchmark test result 15 out of the benchmark test results 13a to 13c stored in the database 14 is output (a benchmark test result outputting step).

The operation of the above benchmark test will now be explained, taking up the case of a benchmark test executed on a semiconductor automatic placing and routing tool as an example.

In FIG. 1, the standard input data 11 can be a netlist showing the logical connections, layout information, cell-timing information, floor plan information, design-timing constraint information and so on, and this input data 11 is fed to each of the tools 12a to 12c so as to obtain the benchmark test results 13a to 13c. These benchmark test results 13a to 13c each can be a list of the resulted layout, the resulted timing and so on as the final result of the placing and routing operation, and can also be a function check list showing whether a timing drive function, a clock tree constructing function and so on are provided, and stored thereafter in the database 14.

As explained above, according to the first embodiment of the present invention, a benchmark test operator does not have to prepare individually an input data and a plurality of test tools for themselves, thereby making it possible to reduce the total cost for performing the benchmark test as a whole. Further, since only a necessary benchmark test result 15 out of a plurality of benchmark test results 13a to 13c can be requested, the benchmark test operator can utilize the test results effectively. Still further, the benchmarking system provider can provide his system as a business by outputting the benchmark test result 15 on payment.

(Second Embodiment)

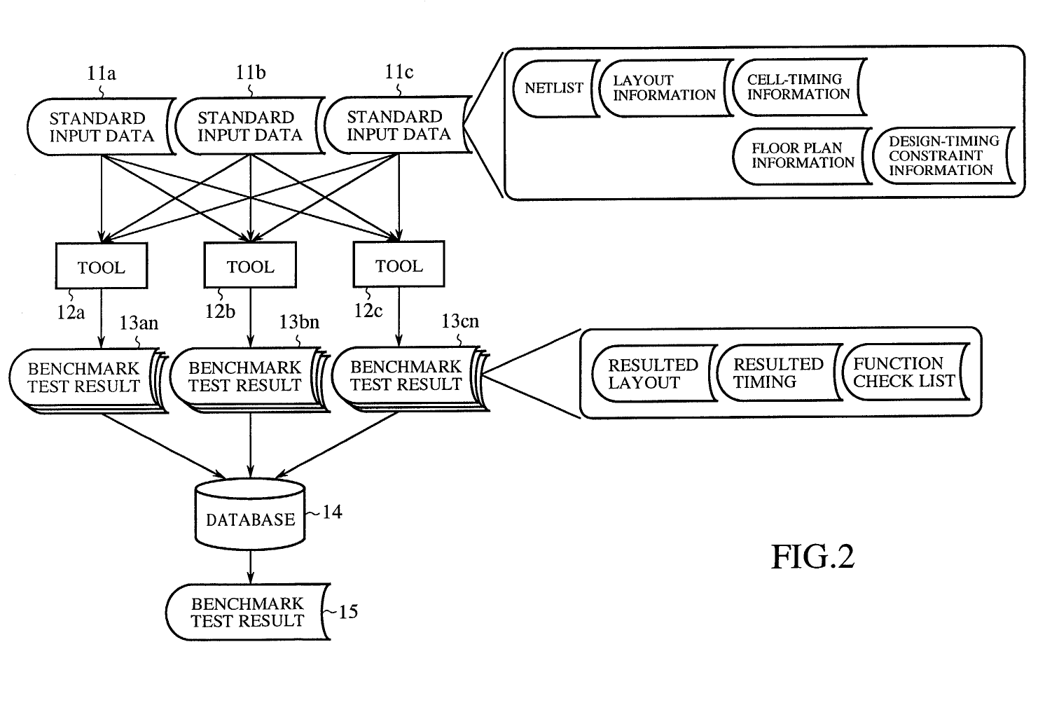

FIG. 2 is a flowchart showing the method of executing a benchmark test according to a second embodiment of the present invention. In the figure, reference numerals 11a to 11c are a plurality of standard input data preinstalled in a computer. Here, it is shown a state in which the benchmark test for three tools 11a to 11c is made possible, although any number of tools other than three can be tested.

In response to an instruction or a request from a benchmark test operator, standard input data selected from a plurality of same standard input data 11a to 11c are fed to each of the plurality of tools 12a to 12c in order to execute a benchmark test for these three tools 12a to 12c (a benchmark test proceeding step). In this case, the results of the benchmark test executed in each of the tools 12a to 12c are the benchmark test results 13an to 13cn, and these benchmark test results 13an to 13cn can be plural in number in accordance with the benchmark test operator's request.

Further, the price is determined in accordance with the content of each of the standard input data, the number of these standard input data specified by the benchmark test operator, and also in accordance with a request from the benchmark test operator for output of the benchmark test results 13an to 13cn, wherein only a required benchmark test result 15 out of the benchmark test results 13an to 13cn stored in the database 14 is output on payment (a benchmark test result outputting step).

The operation of the above benchmark test will now be explained, taking up the case of a benchmark test executed on a semiconductor automatic placing and routing tool as an example.

In the figure, the standard input data 11a to 11c can be a netlist showing the logical connections, layout information, cell-timing information, floor plan information, design-timing constraint information and so on. Here, although it is shown such that many of the netlist, the floor plan information, and the design-timing constraint information exist, any of these standard input data can be made plural. For example, if it is arranged such that there are a plurality of standard input data, the benchmark test operator can freely select which one of the netlist is to be used.

As explained above, according to the second embodiment of the present invention, since a benchmark test operator can obtain the benchmark test results 13an to 13cn by specifying one or more of the plurality of standard input data 11a to 11c as he desires, the benchmark test operator can utilize the test result effectively. Still further, the benchmarking system provider can provide his system as a business by outputting the benchmark test result 15 on payment.

(Third Embodiment)

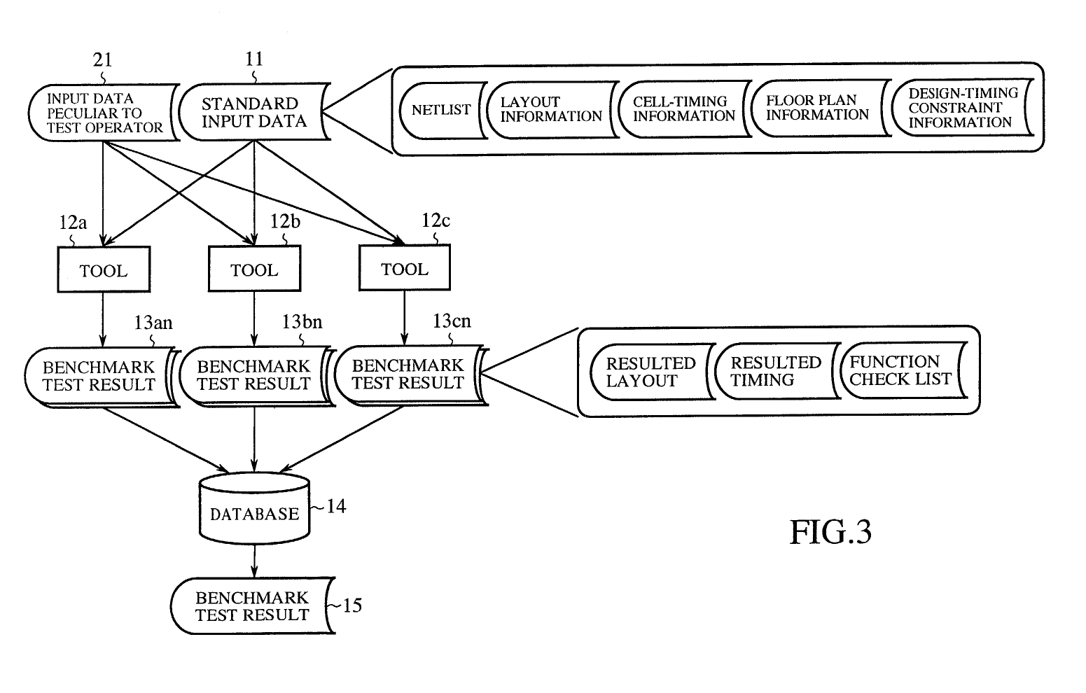

FIG. 3 is a flowchart showing the method of executing a benchmark test according to a third embodiment of the present invention. In the figure, reference numeral 21 denotes an input data peculiar to the benchmark test operator, which is input in response to a request from the benchmark test operator, or transmitted from another computer in response to his transmission request, and maintained thereafter. Although this input data 21 is an input data made by the benchmark test operator himself, and there is only one input data peculiar to himself in this case, it can be any number other than just only one.

In response to an instruction or a request from the benchmark test operator, input data selected from the standard input data 11 and the input data 21 peculiar to the test operator are fed to each of the plurality of tools 12a to 12c so as to execute a benchmark test for these three tools 12a to 12c (a benchmark test proceeding step). In this case, the results of the benchmark test executed in each of the tools 12a to 12c are the benchmark test results 13an to 13cn. Each of these benchmark test results 13an to 13cn is plural in number in accordance with an instruction of the benchmark test operator.

Further, the price is determined in response to the content of each of the standard input data and of the input data peculiar to the test operator, the number of these data, and also in response to a request from the benchmark test operator for output of the test results, wherein only a required benchmark test result 15 out of the benchmark test results 13an to 13cn stored in the database 14 is output on payment (a benchmark test result outputting step).

As explained above, according to the third embodiment of the present invention, since the benchmark test operator can obtain the benchmark test results 13an to 13cn by specifying at least one of the plurality of standard input data 11 and the input data 21 peculiar to the test operator which can be obtained by transmission from outside as he desires, the benchmark test operator can utilize the test results effectively. Further, the benchmarking system provider can provide his system as a business by outputting the benchmark test result 15 on payment.

(Fourth Embodiment)

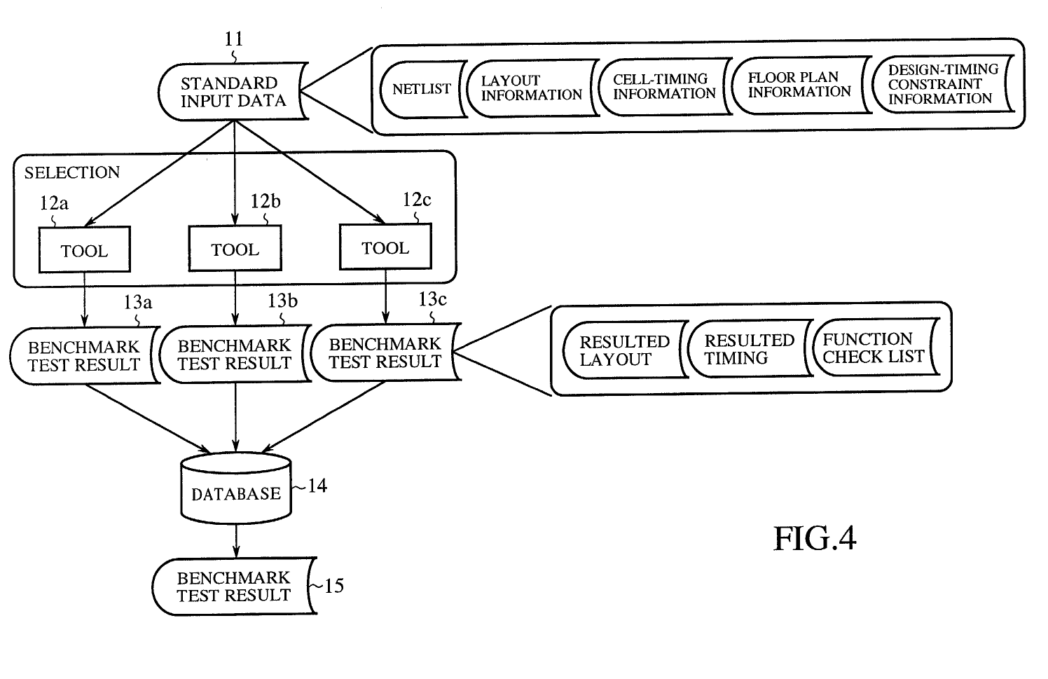

FIG. 4 is a flowchart showing the method of executing a benchmark test according to a fourth embodiment of the present invention. In the figure, in response to an instruction or a request from a benchmark test operator, a standard input data 11 is fed to the selected ones of the plurality of tools 12a to 12c to execute a benchmark test with respect to the thus selected tool (a benchmark test proceeding step). In this case, the number of tools to be selected can be any number.

Further, the price is determined in response to the content and the number of the selected tools, and also in response to a request for the output of the test results from the benchmark test operator, wherein only a required benchmark test result 15 out of the benchmark test results 13a to 13c stored in the database 14 is output (a benchmark test result outputting step).

As explained above, according to the fourth embodiment of the present invention, since the benchmark test operator can obtain the benchmark test results 13a to 13c as he desires by specifying a required tool, the benchmark test operator can utilize the test results effectively. Still further, the benchmarking system provider can provide his system as a business by outputting the benchmark test result 15 on payment.

(Fifth Embodiment)

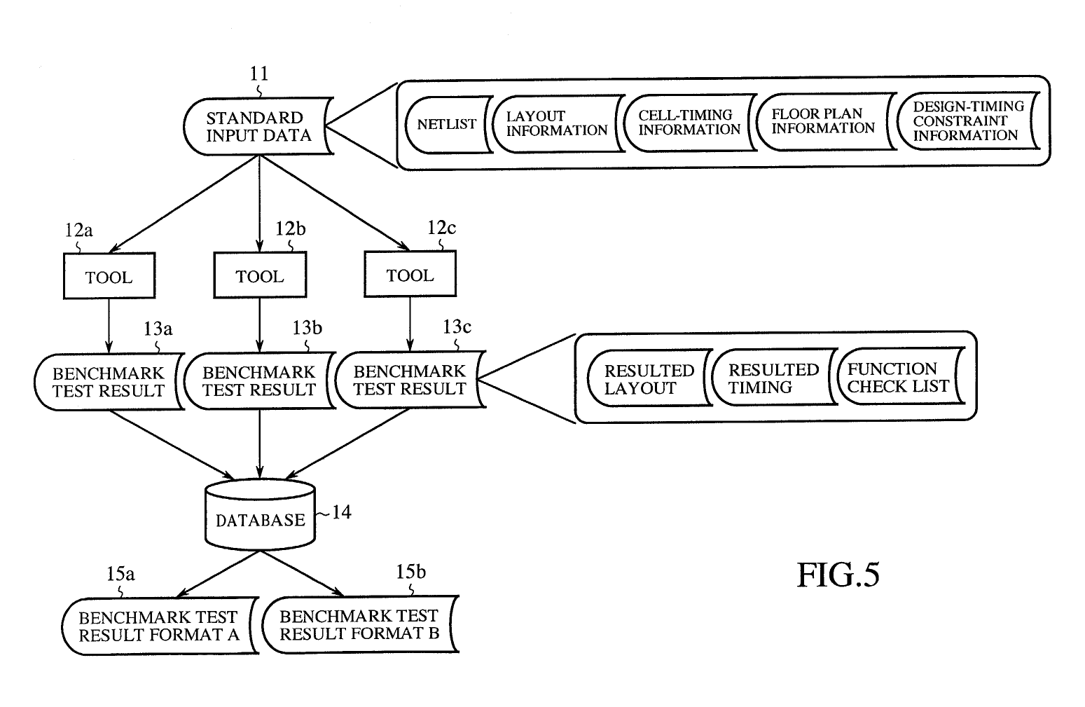

FIG. 5 is a flowchart showing the method of executing a benchmark test according to a fifth embodiment of the present invention. In the figure, numerals 15a and 15b are benchmark test results having different output formats from each other.

In this embodiment, there are provided various formats for outputting the benchmark test results, wherein the price is determined in accordance with the format specified by a benchmark test operator, and the benchmark test results 15a and 15b are outputted by the thus specified format on payment (a benchmark test result outputting step). In this case, there is no limitation in the number of formats to be selected.

As explained above, according to the fifth embodiment of the present invention, the benchmark test operator can obtain one or both the benchmark test results 15a and 15b by specifying one or both of the formats A and B in which these benchmark test results 15a and 15b are written from a plurality of formats, so that the benchmark test operator can utilize the test result effectively. Still further, the benchmarking system provider can provide his benchmarking system as a business by outputting the benchmark test result 15 on payment.

(Sixth Embodiment)

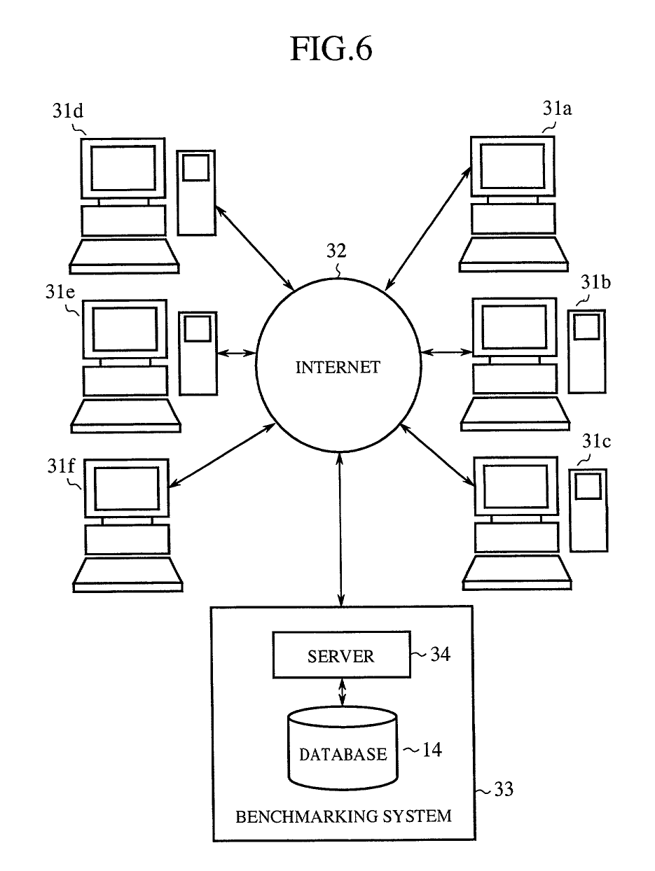

FIG. 6 is an overall structural view showing the case in which the method of executing a benchmark test according to a sixth embodiment of the present invention is applied to the Internet. In the figure, reference numerals 31a to 31f denote terminal devices for each of the benchmark test operators configured by personal computers, and numeral 32 denotes the Internet. Further, numeral 33 denotes a benchmarking system as observed in the first to fifth embodiments configured by a computer or the like, and numeral 34 denotes a server disposed therein.

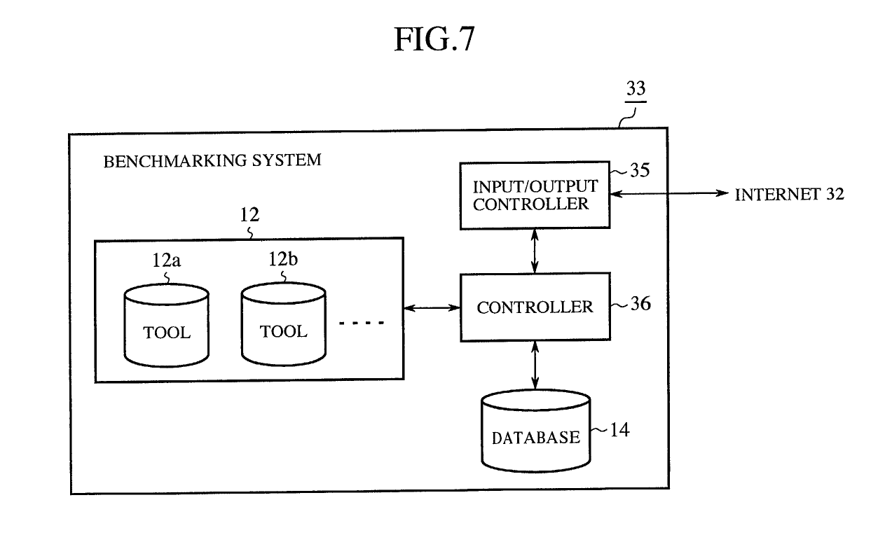

FIG. 7 is a functional block diagram showing the benchmarking system according to the sixth embodiment of the present invention. In the figure, reference numeral 35 denotes an input/output controller, which inputs various requests through the Internet, and/or outputs the benchmark test results or the like to the Internet, numeral 36 denotes a controller, which executes a benchmark test for a plurality of tools 12 (12a, 12b, . . . on inputting various requests from the input/output controller 35, stores a plurality of test results in the database 14, reads out the benchmark test results from the database 14 on inputting various requests, and outputs the thus read out data to the input/output controller 35.

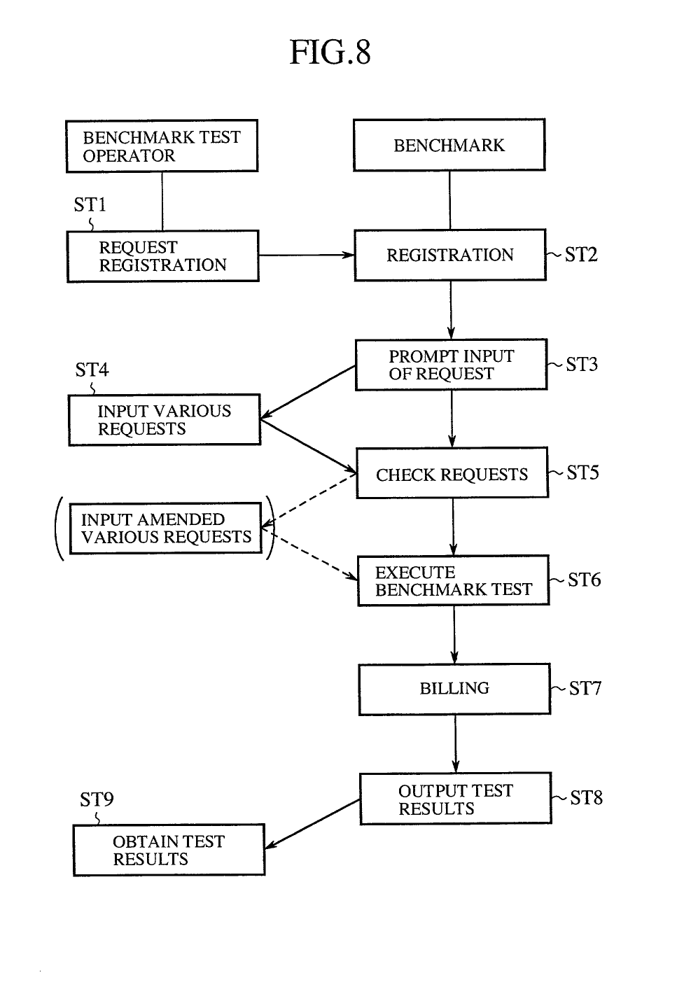

FIG. 8 is a flowchart showing the method of executing a benchmark test according to the sixth embodiment of the present invention.

The operation of the benchmark test according to the sixth embodiment applied to the Internet will now be explained as below.

A benchmark test operator requests registration of benchmark test by use of, for example, a terminal device 31a to the benchmarking system 33 through the Internet 32 (step ST1). The input/output controller 35 of the benchmarking system 33 inputs the registration request, and the controller 36 registers the data such as the name of the benchmark test operator or the like in the database 14 on receiving the registration request (Step ST2). Thereafter, the controller 36 prompts an input of request to the benchmark test operator who has requested the registration, and the input/output controller 35 outputs the prompting of the input request to the terminal device 31a by way of the Internet 32 (step ST3).

Here, the benchmark test operator requests an execution of the benchmark test, and also requests an output of data as to which of the benchmark test results should be obtained by use of the terminal device 31a as shown in the first embodiment, specifies as to which of the plurality of standard input data should be fed as shown in the second embodiment, provides through transmission an input data peculiar to the test operator as shown in the third embodiment, specifies as to which of the plurality of tools should be tested as shown in the fourth embodiment, and also specifies as to in which format the benchmark test results should be outputted as shown in the fifth embodiment (step ST4).

The input/output controller 35 of the benchmarking system 33 inputs these requests, and the controller 36 confirms those requests (step ST5). Here, if the inputted request is not a proper one, the controller 36 prompts an input of the request to the benchmark test operator again, and waits for an amended request from the benchmark test operator.

Thereafter, if the inputted request is a proper one, the controller 36 executes the benchmark test in accordance with those various requests (step ST6), thereafter stores the benchmark test result in the database 14, and makes a bill of a price corresponding to the inputted requests under the name of the benchmark test operator Step ST7). Further, the benchmark test result and the price in correspondence to the requests are output to the benchmark test operator, and then the input/output controller 35 outputs those data to the terminal device 31a by way of the Internet (step ST8).

The benchmark test operator obtains the benchmark test result and the price by the terminal device 31a connected to the Internet 32.

As explained above, according to the sixth embodiment of the present invention, the benchmark test operator can utilize the method of executing a benchmark test shown in the first to fifth embodiments by way of a network such as the Internet 32.

As explained heretofore, according to the present invention, the method of executing a benchmark test comprises: a benchmark test proceeding step in which at least one standard input data preinstalled in a computer is fed to a plurality of tools also preinstalled in a computer so as to execute a benchmark test with respect to these tools, a benchmark test result storing step in which a plurality of benchmark test results obtained during the benchmark test proceeding step are stored, and a benchmark test result outputting step in which at least one of the plurality of benchmark test results stored during the test result storing step is outputted on the benchmark test operator's request. Due to this construction, benchmark test operators do not have to prepare individually an input data and a plurality of test tools for themselves, making it possible thereby to reduce the total cost for performing the benchmark test as a whole. Further, since only a necessary benchmark test result out of a plurality of benchmark test results can be requested, the benchmark test operator can utilize the test results effectively. Still further, the benchmark test can be executed and the test result thereof can be required and obtained all by way of a network such as the Internet.

According to the present invention, the method of executing a benchmark test is constructed in such a manner that there are plurality of standard input data provided in the benchmark test proceeding step, and only selected ones of the standard input data out of the plurality of standard input data are input to each of the plurality of tools on request in order to execute the benchmark test with respect to these tools. Due to this construction, since a benchmark test operator can obtain the benchmark test results by specifying one or more of the plurality of standard input data as he desires, the benchmark test operator can utilize the test result effectively. Still further, the execution of a benchmark test based on the required standard input data can be requested and the test result thereof can be obtained both by way of a network such as the Internet.

According to the present invention, the method of executing a benchmark test is constructed in such a manner that a test operator's own input data is further provided through transmission on request, and at least one of the test operator's own input data and the standard input data is fed to the plurality of tools in order to execute the benchmark test with respect to those tools. Due to this construction, since the benchmark test operator can obtain the benchmark test results by specifying at least one of the plurality of standard input data and the input data peculiar to the test operator which can be obtained by transmission from outside as he desires, the benchmark test operator can utilize the test results effectively. Still further, the input data peculiar to the test operator can be provided through transmission, execution of a benchmark test can be requested and the test result thereof can be obtained all by way of a network such as the Internet.

According to the present invention, the method of executing a benchmark test is constructed in such a manner that the standard input data is input, on request, to one or more than one tools selected out of the plurality of tools in order to execute the benchmark test for selected those tools. Due to this construction, since the benchmark test operator can obtain the benchmark test results as he desires by specifying a required tool, the benchmark test operator can utilize the test results effectively. Still further, execution of a benchmark test can be requested and the required benchmark test result can be obtained all by way of a network such as the Internet.

According to the present invention, the method of executing a benchmark test is constructed in such a manner that only the required benchmark test results out of the plurality of benchmark test results stored during the benchmark test result storing step are outputted in a required format. Due to this construction, the benchmark test operator can obtain the benchmark test results by selecting one or some formats in which these benchmark test results are written from a plurality of formats, so that the benchmark test operator can utilize the test result effectively. Still further, the required benchmark test result can be requested and obtained both by way of a network such as the Internet.

According to the present invention, the method of executing a benchmark test is constructed in such a manner that only the required benchmark test results out of the plurality of benchmark test results stored during the benchmark test result storing step are outputted on payment. Due to this construction, the benchmarking system provider can provide his system as a business by outputting the benchmark test result on payment. Further, the benchmarking system provider can provide his system as a business through a network such as the Internet.

What is claimed is:

1. A method of executing a benchmark test comprising:
a benchmark test proceeding step in which at least one standard input data preinstalled in a computer is fed to a plurality of tools also preinstalled in a computer so as to execute a benchmark test with respect to said tools,
a benchmark test result storing step in which a plurality of benchmark test results obtained during said benchmark test proceeding step are stored, and
a benchmark test result outputting step in which at least one of the plurality of benchmark test results stored during said test result storing step is outputted on request.

2. The method of executing a benchmark test according to claim 1, wherein there are a plurality of standard input data provided in said benchmark test proceeding step, and only selected ones of said standard input data out of said plurality of standard input data are fed to each of said plurality of tools on request.

3. The method of executing a benchmark test according to claim 1, wherein a test operator's own input data is further provided by transmission on request, and at least one of said test operator's own input data and said standard input data is fed to said plurality of tools.

4. The method of executing a benchmark test according to claim 1, wherein said standard input data is input on request to one or more than one tools selected out of said plurality of tools in order to execute the benchmark test for those selected tools.

5. The method of executing a benchmark test according to claim 1, wherein only the required benchmark test results out of said plurality of benchmark test results stored during said benchmark test result storing step are outputted in a required format.

6. The method of executing a benchmark test according to claim 1, wherein only the required benchmark test results out of said plurality of benchmark test results stored during said benchmark test result storing step are outputted on payment.
